(19) United States
(12) Patent Application Publication
(10) Pub. No.: US 2014/0195980 A1
(43) Pub. Date: Jul. 10, 2014

(54) DISPLAY APPARATUS AND METHOD FOR PROVIDING USER INTERFACE THEREOF

(71) Applicant: Samsung Electronics Co., Ltd., Suwon-si (KR)

(72) Inventor: Hae-in LEE, Seongnam-si (KR)

(73) Assignee: Samsung Electronics Co., Ltd., Suwon-si (KR)

(21) Appl. No.: 14/147,082

(22) Filed: Jan. 3, 2014

Related U.S. Application Data
(60) Provisional application No. 61/748,994, filed on Jan. 4, 2013.

(30) Foreign Application Priority Data
Aug. 8, 2013 (KR) 10-2013-0094359

(51) Int. Cl. G06F 3/0484; G06F 3/0481

(52) U.S. Cl. CPC G06F 3/04842; G06F 3/04817
USPC 715/835

(57) ABSTRACT

A display apparatus and a user interface providing method thereof are provided. The method including: in response to a command being input, displaying user interface comprising at least one icon which represents a current setting status of the display apparatus on one area of a display screen; and in response to an icon of the at least one icon being selected, changing a setting status of a function of the display apparatus corresponding to the selected icon.

### CROSS-REFERENCE TO RELATED APPLICATIONS

This application claims priority from Korean Patent Application No. 10-2013-0094359, filed in the Korean Intellectual Property Office on Aug. 8, 2013, and the benefit of U.S. Provisional Application No. 61/748,994, filed in the U.S. Patent and Trademark Office on Jan. 4, 2013, the disclosures of which are incorporated herein by reference in their entireties.

### BACKGROUND

1. Field

Apparatuses and methods consistent with exemplary embodiments relate to a display apparatus and a method for providing a user interface thereof, and more particularly, to a display apparatus capable of displaying a user interface which guides users to a current setting status and a method for providing the user interface thereof.

2. Description of the Related Art

With advances in technology a display apparatus may not only provide a broadcast program display function but may also provide other various functions. For example, such a display apparatus may provide a voice recognition function and a motion recognition function configured to receive a user command, provide a wired or wireless network connection function to provide external content, and provide a user log-in function to provide function customization to users.

However, a user needs to check a setting status of each function in order to change to the setting status. For example, in order to check whether a voice recognition function or a motion recognition function is turned on, a user entered into the menu for setting the voice recognition function or the motion recognition function. That is, the related art display apparatus may not allow a user to check the current setting status of the display apparatus in an easy and convenient manner.

In addition, in order to change the setting status of various functions of the display apparatus, a user enters into each menu corresponding to the function of which setting status is to be changed. That is, the display apparatus requires complex menu navigation and multiple user inputs to change the setting status.

### SUMMARY

Exemplary embodiments provide a display apparatus capable of checking the setting status of various functions and changing the setting status of the display apparatus more easily and intuitively, and a method for providing user interface thereof.

According to an aspect of an exemplary embodiment, there is provided a method for providing a user interface of a display apparatus, the method including: in response to a command being input, displaying user interface including at least one icon which represents a current setting status of the display apparatus on one area of a display screen; and in response to an icon of the at least one icon being selected, changing a setting status of a function of the display apparatus corresponding to the selected icon.

The at least one icon may include at least one of an icon corresponding to a voice recognition function, an icon corresponding to a motion recognition function, an icon corresponding to a user log-in function, an icon corresponding a wired or wireless network setting, and an icon corresponding to a notification function.

The changing the setting status may include, in response to an icon corresponding to the current setting status being off being selected from among the at least one icon, turning on the setting status of the function of the display apparatus corresponding to the at least one icon.

The changing the setting status may include, in response to an icon corresponding to the current setting status being on being selected from among the at least one icon, displaying the user interface which is configured to set a function of the display apparatus corresponding to the selected icon in detail.

The changing the setting status may include, in response to the icon corresponding to the user log-in function being selected from among the at least one icon, displaying the user interface to perform user log-in.

The changing the setting status may include, in response to the icon corresponding to the wired or wireless network setting being selected from among the at least one icon, displaying the user interface for setting wired or wireless network setting.

The changing the setting status may include, in response to the icon corresponding to the notification function being selected from the at least one icon, displaying a list including notification information.

The changing the setting status may further include in response to an icon corresponding to a task performed by a current display apparatus being selected from the list, displaying an icon regarding change in a function of a task corresponding to the selected icon.

The user interface may include a form that is displayed on an upper area of the display screen.

According to an aspect of another exemplary embodiment, there is provided a display apparatus including a display; an input unit configured to receive a user command; and a controller configured to, in response to a command being received by the input unit, control the display to display a user interface including at least one icon which represents a current setting status of the display apparatus on one area of the display, and in response to an icon of the at least one icon being selected through the input unit, change a setting status of a function corresponding to the selected icon.

The at least one icon may include at least one of an icon corresponding to a voice recognition function, an icon corresponding to a motion recognition function, an icon corresponding to a user log-in function, an icon corresponding a wired or wireless network setting, and an icon corresponding to a notification function.

The controller may be configured to, in response to an icon corresponding to the current setting status being off being selected from among the at least one icon through the input unit, turn on a setting status of a function of the display apparatus corresponding to the selected icon.

The controller may be configured to, in response to an icon corresponding to the current setting status being on being selected from among the at least one icon through the input unit, display the user interface to set a function of the display apparatus corresponding to the selected icon in detail.

The controller may be configured to, in response to the icon corresponding to the user log-in function being selected from among the at least one icon through the input unit, control the display to display the user interface for user log-in.

The controller may be configured to, in response to the icon corresponding to the wired or wireless network setting is selected from among the at least one icon through the input unit, control the display to display the user interface for setting wired or wireless network setting.

The controller may be configured to, in response to the icon corresponding to the notification function is selected from among the at least one icon through the input unit, control the display to display a list including notification information.

The controller may be configured to, in response to an item corresponding to a task performed by a current display apparatus being selected from the list through the input unit, control the display to display an icon regarding change in a function of a task corresponding to the selected item.

The user interface may include a bar that is displayed on an upper area of the display screen.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a configuration of a display apparatus according to an exemplary embodiment;

FIG. 2 is a block diagram illustrating a configuration of a display apparatus according to an exemplary embodiment;

FIG. 3 is a view illustrating a status bar according to an exemplary embodiment;

FIGS. 4 through 8 are views provided to explain examples for changing the setting status of various functions of a display apparatus using a status bar according to various exemplary embodiments; and

FIG. 9 is a flowchart provided to explain a method for providing a user interface on a display apparatus according to an exemplary embodiment.

### DETAILED DESCRIPTION

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

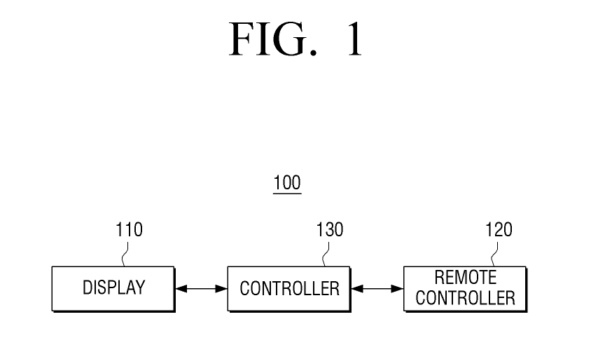

FIG. 1 is a block diagram illustrating configuration of a display apparatus 100 briefly according to an exemplary embodiment. As illustrated in FIG. 1, the display apparatus 100 includes a display 110, an input unit 120, which may be, more specifically, a remote controller 120, and a controller 130.

The display 110 outputs image data under the control of the controller 130. In particular, when a command, which may be predetermined, is input through the input unit 120, the display 110 may display a user interface including at least one icon which represents the current setting status of the display apparatus on one portion of the display screen. In this exemplary embodiment, the display 110 may display the user interface in the form of a bar in an upper area of the display screen.

The input unit 120 may receive a user command to control overall operations of the display apparatus 100. In particular, the input unit 120 may receive a user command, which may be predetermined, to the display user interface including at least one icon which represents the current setting status of the display apparatus 100. The input unit 120, according to an exemplary embodiment, may be realized as a remote controller including four direction keys which correspond to up, down, right, and left keys and an enter key, but is not limited thereto.

The controller 130 controls overall operations of the display apparatus 100 according to a user command input through the input unit 120. In particular, when a command, which may be predetermined, is input through the input unit 120, the controller 130 may control the display 110 to display a user interface including at least one icon which represents the current setting status of the display apparatus 100 on one portion of the display 110. In this case, the at least one icon may include at least one of an icon corresponding to a voice recognition function, an icon corresponding to a motion recognition function, an icon corresponding to a user log-in function, an icon corresponding a wired or wireless network setting, and an icon corresponding to a notification function. In addition, the controller 130 may control the display to display the overall shape or shape of icons differently according to the current setting status of the display apparatus 100.

When one of the icons is selected through the input unit 120, the controller 130 may change the setting status of the function of the display apparatus 100 corresponding to the selected icon.

In an exemplary embodiment, when an icon corresponding to a current setting status that is ‘off’ is selected while icons corresponding to the functions of the display apparatus 100 which could be turned on/off, such as a voice recognition function or a motion recognition function, are displayed, the controller 130 may turn on the setting status of the function of the display apparatus 100 corresponding to the selected icon. Alternatively, when an icon corresponding to a current setting status that is ‘on’ is selected, the controller 130 may control the display 110 to display the user interface to set the function of the display apparatus 100 corresponding to the selected icon in detail. In another exemplary embodiment, when an icon corresponding to a current setting status is ‘off’ is selected, the controller 130 may control the display 110 not to directly convert the setting status of the function of the display apparatus 100 corresponding to the selected icon to ‘on’ but to display user interface to set the function of the display apparatus 100 corresponding to the selected icon in detail.

In another exemplary embodiment, when an icon corresponding to a user log-in function is selected while the icon corresponding to the user log-in function is displayed, the controller 110 may control the display 110 to display user interface for user log-in. If the display apparatus 100 is already logged-in by a specific user and the icon corresponding to the user log-in function is selected, the controller 130 may control the display 110 to display user interface to perform log-out of the specific user and/or log-in of another user.

In another exemplary embodiment, if an icon corresponding to a wired or wireless network setting is selected while the icon corresponding to the wired or wireless network setting is displayed, the controller 130 may control the display 110 to display user interface for wired or wireless network setting.

In another exemplary embodiment, if an icon corresponding to a notification function is selected while the icon corresponding to the notification function is displayed, the controller 130 may control the display 110 to display a list including notification information of the current display apparatus 100. In addition, if an item corresponding to a task performed by the current display apparatus is selected from the list including notification information, the controller 130 may control the display 110 to display an icon regarding the change in the function of a task corresponding to the selected item.

As described above, according to various exemplary embodiments, a user may check the setting status of various functions of a display apparatus and change the setting status more easily and intuitively.

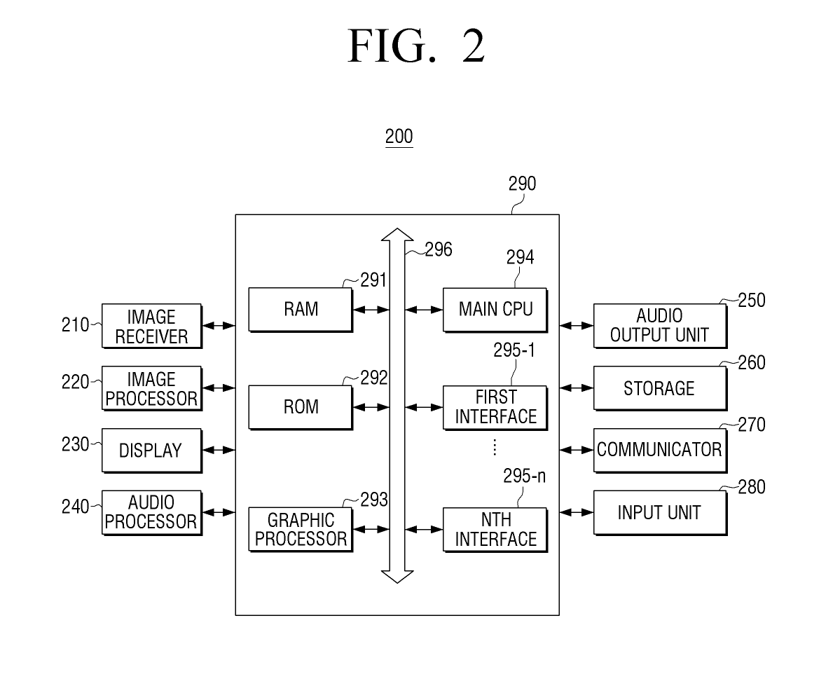

Hereinafter, a display apparatus 200 will be explained in greater detail with reference to FIGS. 2 through 8. FIG. 2 is a block diagram illustrating configuration of the display apparatus 200 in detail according to an exemplary embodiment. As illustrated in FIG. 2, the display apparatus 200 comprises an image receiver 210, an image processor 220, a display 230, an audio processor 240, an audio output unit 250, a storage 260, a communicator 270, an input unit 280, and a controller 290.

The display apparatus 200 of FIG. 2 may be an apparatus for performing various functions such as a content recommendation function, a communication function, a video reproduction function, a display function, and so on, and each element is described in a comprehensive manner. Thus, depending on exemplary embodiments, some elements illustrated in FIG. 2 may be omitted or changed, or other elements may be added.

The image receiver 210 receives image data through various sources. For example, the image receiver 210 may receive broadcast data from an external broadcasting station, may receive image data from an external device, and may receive image data stored in the internal storage 260, RAM 291, or ROM 292.

The image processor 220 processes image data received from the image receiver 210. The image processor 220 may perform various processing with respect to image data such as decoding, scaling, noise filtering, frame rate conversion, resolution conversion, and so on.

The display 230 displays at least one of a video frame which is processed by the image processor 220 after being received from the image receiver 210 and various screens generated by a graphic processor 293. In particular, the display 230 may display user interface in the form of bar including at least one icon which represents the current setting status of the display apparatus on one portion (for example, on an upper area) of the display screen.

The audio processor 240 processes audio data. The audio processor 240 may perform various processing with respect to audio data such as decoding, amplification, noise filtering, and so on. The audio data processed by the audio processor 240 may be output to the audio output unit 250.

The audio output unit 250 outputs not only various audio data processed by the audio processor 240 but also various sounds and voice messages. In this exemplary embodiment, the audio output unit 250 may be realized as a speaker, but it is only an example. The audio output unit 250 may be realized as an audio terminal.

The storage 260 stores various modules to drive the display apparatus 200. For example, the storage 260 may store software including a base module, a sensing module, a communication module, a presentation module, a web browser module, and a service module. In this exemplary embodiment, the base module refers to a basic module which processes a signal transmitted from the hardware included in the display apparatus 200, and transmits the processed signal to an upper layer module. The sensing module is configured to collect information from various sensors, and analyzes and manages the collected information. The sensing module may include a face recognition module, a voice recognition module, a motion recognition module, and an near field communication (NFC) recognition module, and so on. The presentation module is configured to compose a display screen. The presentation module includes a multimedia module for reproducing and outputting multimedia content, and a UI rendering module for UI and graphic processing. The communication module is configured to perform communication with the outside. The web browser module r accesses a web server by performing web-browsing. The service module includes various applications for providing various services.

As described above, the storage 260 may include various program modules, but some of the various program modules may be omitted, changed, or added according to the type and attribute of the display apparatus 200. For example, when the display apparatus 200 is realized as a smart phone, the base module may further comprise a location determination module to determine a GPS-based location, and the sensing module may further comprise a sensing module to detect a user motion.

The communicator 270 performs communication with various types of external apparatuses according to various types of communication methods. The communicator 270 may comprise various communication chips such as a WiFi chip, a Bluetooth chip, an NFC chip, a wireless communication chip and so on. In this case, the WiFi chip, the Bluetooth chip, and the NFC chip perform communicate according to a WiFi method, a Bluetooth method, and an NFC method respectively. The NFC chip refers to a chip which operates according to an NFC method by using 13.56 MHz from among various RF-ID frequency bands such as 135 kHz, 13.56 MHz, 433 MHz, 860˜960 MHz, 2.45 GHz, and so on. When the WiFi chip or the Bluetooth chip is used, various connection information such as SSID, session key, etc. is received/transmitted in advance so that various information can be received/transmitted using the same. The wireless communication chip performs communication according to various communication standards such as IEEE such as 802.11, Zigbee, 3rd Generation (4G), 3rd Generation Partnership Project (3GPP), Long Term Evolution (LTE), and so on.

The input unit 280 may receive a user command to control overall operations of the display apparatus 200. In particular, the input unit 280 may receive a user command to generate a user interface including at least one icon which represents the current setting status of functions of the display apparatus 200. In addition, the input unit 280 may receive a user command to change the setting status of one of user interfaces including at least one icon which represents the current setting status of functions of the display apparatus 200.

In this case, the input unit 280 may be realized as a remote controller including four direction keys, that is, up, down, left, and right keys, and an enter key, but this is only an example. The input unit 280 may be realized as various input apparatuses such as a touch screen, a mouse, a pointing device, a microphone, a camera, and so on.

The controller 290 may control overall operations of the display apparatus 200 using various programs stored in the storage 260.

As illustrated in FIG. 2, the controller 290 comprises a random access memory (RAM) 291, a read only memory (ROM) 292, a graphic processor 293, a main central processing unit (CPU) 294, a first to nth interfaces 295-1˜295-n, and a bus 296. In this case, the RAM 291, the ROM 292, the graphic processor 293, the main CPU 294, and the first to nth interfaces 295-1˜295-n may be connected to each other through the bus 296.

The ROM 292 may store a set of commands for system booting. For example, if a turn-on command is input and power is supplied, the main CPU 294 may copy an O/S stored in the storage 260 onto the RAM 291 according to a command stored in the ROM 292 and may then boot a system by executing the O/S. If the booting is completed, the main CPU 294 copies various application programs stored in the storage 260 onto the RAM 291 and performs the various operations by executing the application programs copied in the RAM 291.

The graphic processor 293 generates a screen including various objects such as an icon, an image, and a text using a computing unit and a rendering unit. The computing unit computes property values such as coordinates, shape, size, and color of each object to be displayed according to the layout of the screen using a control command received from the input unit 280. The rendering unit generates a screen with various layouts including objects based on the property values computed by the computing unit. The screen generated by the rendering unit is displayed within the display area of the display 230.

The main CPU 294 accesses the storage 260 and performs booting using an O/S stored in the storage 260, and performs various operations using various programs, content, and data stored in the storage 260.

The first to nth interfaces 295-1˜295-n are connected to the above-described various components. One of the interfaces may be a network interface which is connected to an external apparatus via network.

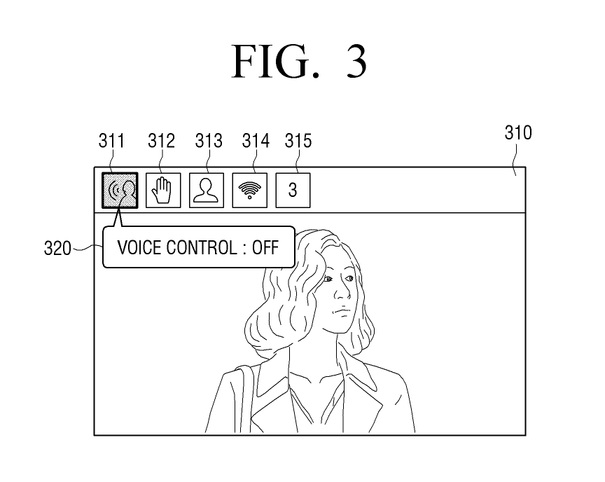

When a command, which may be predetermined, is input through the input unit 280, the controller 290 may control the display 230 to display a user interface including at least one icon which represents the current setting status of the display apparatus 200 on one portion of the display 230. For example, if the input unit 280 is realized as a remote controller and a button, which may be predetermined, on the remote controller is selected, the controller 290 may control the display 230 to display a status check bar 310 including at least one icon which represents the current setting status of the display apparatus 200 as illustrated in FIG. 3. In this case, the status check bar 310 may include at least one of a first icon 311 corresponding to a voice recognition function, a second icon 312 corresponding to a motion recognition function, a third icon 313 corresponding to a user log-in function, a fourth icon 314 corresponding a wired or wireless network setting, and a fifth icon 315 corresponding to a notification function.

In addition, if the input unit 280 is realized as a remote controller, the controller 290 may move a cursor to select an icon of the status check bar 310 according to a user input using the left and right direction keys of the remote controller. In addition, the controller 290 may change the current setting status of a function corresponding to the icon where the cursor is located according to a user input using the enter key of the remote controller.

Further, the controller 290 may control the display 230 to display the shape or shade of icons differently according to the current setting status. Specifically, the controller 290 may control the display 230 to display an indicator (for example, ‘X’ mark) which indicates that the current setting status is ‘off’ along with the icon corresponding to the function corresponding to a current setting status that is ‘off’, or may control the display 230 to display the icon corresponding to a current setting status that is ‘on’ darker than other icons. For example, if the current setting status of the motion recognition function or the voice recognition function is ‘off’, the controller 290 may control the display 230 to display an indicator which indicates that the current setting status of the first icon 311 and the second icon 312 is ‘off’, or to display the icon darker than other icons in case where the setting status of the motion recognition function or the voice recognition function is ‘on’. In another example, if log-in is not performed by any specific user account, the controller 290 may control the display 230 to display an indicator which indicates that the current setting status is ‘log-out’ on the third icon, or to display the icon darker than other icons in case where log-in is performed by a specific user account. In addition, the controller 290 may control the display 230 to display the fourth icon by determining the connection quality of the current wireless network. Further, the controller 290 may control the display 230 to indicate the number of notification information on the fifth icon by determining the number of notification information stored in the current display apparatus 200.

According to another exemplary embodiment, the controller 290 may also display a guidance window 320 which guides the current setting status of an icon where a cursor is located from among icons included in the status check bar 310. For example, if the cursor is located on the first icon 311, the controller 230 may control the display 230 to display the guidance window 320 which indicates that the voice recognition function is currently turned off by determining the current setting status of the voice recognition function.

If at least one icon included in the UI (for example, the status check bar) is selected through the input unit 280, the controller 290 may change the setting status of the function of the display apparatus 100 corresponding to the selected icon.

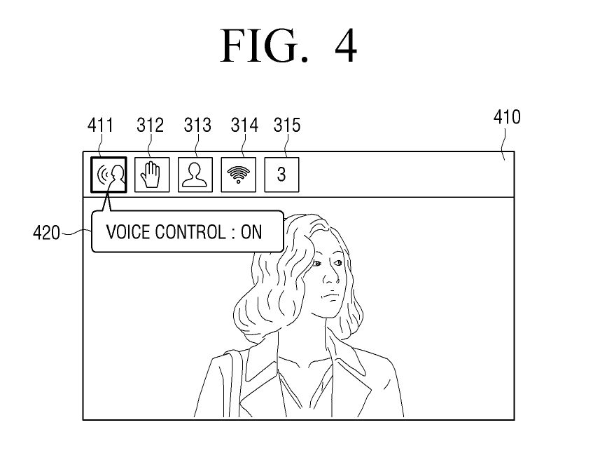

In an exemplary embodiment, if an icon, corresponding to a current setting status that is ‘off’, is selected from among the at least one icon through the input unit 280, the controller 290 may turn on the setting status of the function of the display apparatus corresponding to the selected icon. For example, as illustrated in FIG. 3, if a cursor is located on the first icon 311 and a selection command (for example, a command to select the enter key of the remote controller) is input through the input unit 280, the controller 290 may turn on the voice recognition function. In addition, as illustrated in FIG. 4, the controller 290 may display a first icon 311 brighter than the exemplary embodiment where the voice recognition function is turned off, and may control the display 230 to display a guidance window 420 which indicates that the voice recognition function is turned on.

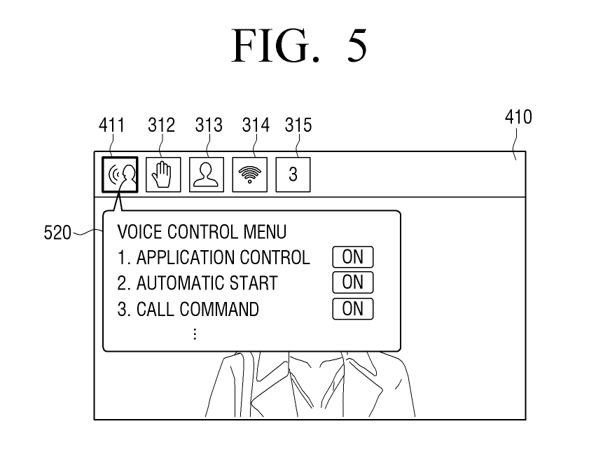

In addition, if an icon corresponding to a current setting status that is ‘on’ is selected from among the at least one icon through the input unit 280, the controller 290 may control the display 230 to display a user interface configured to set the function of the display apparatus corresponding to the selected icon in detail. For example, as illustrated in FIG. 4, if a cursor is located on the first icon 411 in a guide bar 410 and a selection command is input through the input unit 280, the controller 290 may control the display 230 to display a menu window 520 for setting the voice recognition function in detail as illustrated in FIG. 5.

As the method for changing the motion recognition function is similar to the method for changing the voice recognition function, the detailed description thereof will not be provided. According to the above-described method, a user may turn on or off the voice recognition function or the motion recognition function of the display apparatus 200 using the first icon 311 or the second icon 312, respectively.

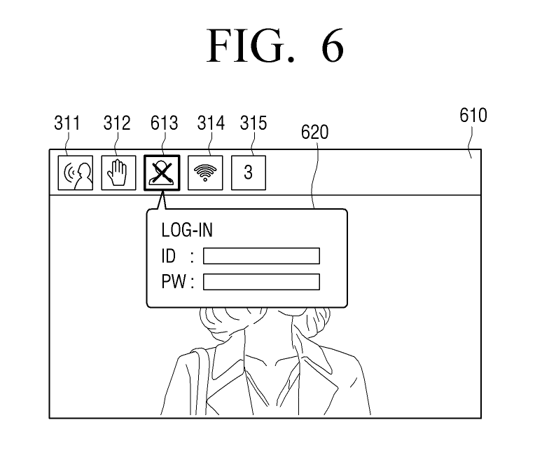

In another exemplary embodiment, if the third icon 313 corresponding to the user log-in function is input through the input unit 280, the controller 290 may control the display 230 to display a user interface for performing user log-in. For example, as illustrated in FIG. 6, if a selection command is input while the cursor is located on a third icon 613 in the guide bar 610, the controller 290 may control the display 230 to display a log-in window 620 for performing user log-in. In this exemplary embodiment, if log-in is not performed by any specific user account in the display apparatus 200, the controller 290 may control the display 230 to display the log-in window 620 as illustrated in FIG. 6. If the third icon 613 is selected while a specific user account is logged into the display apparatus 200, the controller 290 may control the display 230 to display a window for performing log-out of the logged-in user account or for performing log-in by another user account. According to the above-described method, a user may perform log-in or log-out using the third icon 613.

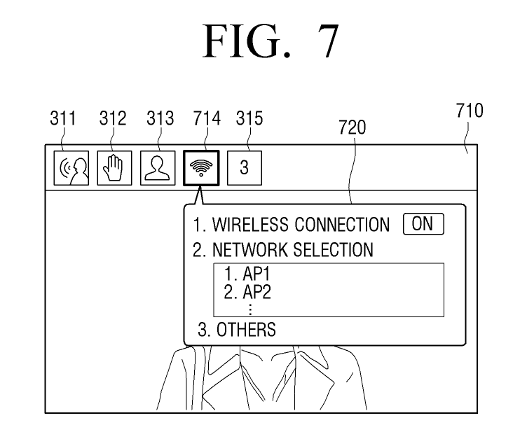

In another exemplary embodiment, if the fourth icon corresponding to a wired or wireless network setting is selected from among the at least one icon through the input unit 290, the controller 290 may control the display 230 to display user interface for setting wired or wireless network. For example, as illustrated in FIG. 7, when a selection command is input while a cursor is located on a fourth icon 714 in the guide bar 710, the controller 290 may control the display 230 to display a setting window 720 for setting wired or wireless network in detail. According to the above-described method, a user may change the wired or wireless network setting using the fourth icon 714.

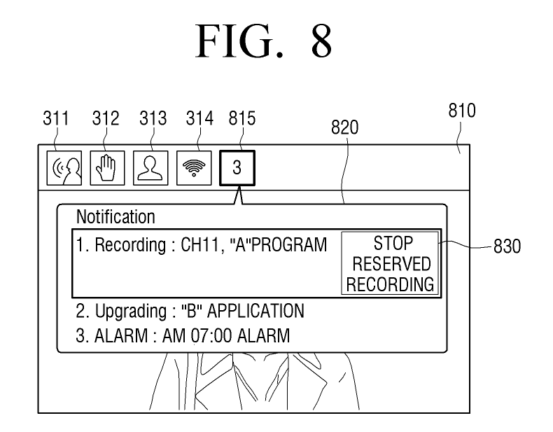

In another exemplary embodiment, if the fifth icon 315 corresponding to a notification function is selected from among the at least one icon, the controller 290 may control the display 230 to display a list including notification information. For example, as illustrated in FIG. 8, when a selection command is input while a cursor is located on a fifth icon 815, the controller 290 may control the display 230 to display a list 820 including notification information stored in the current display apparatus 200.

In this case, if one of items included in the list is selected through the input unit 280, the controller 290 may control the display 230 to display an icon regarding the change of a task corresponding to the selected item. For example, as illustrated in FIG. 8, when a selection command is input while the cursor is located on an item which guides the recording function performed by the current display apparatus 200, the controller 290 may control the display 230 to display a recording stop icon 830 to stop the recoding function corresponding to the first item. According to the above-described method, a user may check notification information of the current display apparatus 200 using the fifth icon, and change the function of the display apparatus 200.

In FIGS. 3 to 8, the user interface is in the form of bar (310 through 810) configured to check and change the current status of the function of the display apparatus 100. However, this is only an example, and the user interface may be provided in other forms (for example, in the form of slide, menu, etc.).

In FIGS. 3 to 8, the status check bar (310 through 810) is displayed on the upper end of the display screen, but this is only an example. The status check bar may be displayed on other areas (such as, the lower end, left side, etc.) of the display screen.

In addition, in FIGS. 3 to 8, the status check bar (310 through 810) includes the first to the fifth icon (311, 312, 313, 314, 315), but this is only an example. The status check bar may include icons corresponding to other functions (for example, a pointing device function).

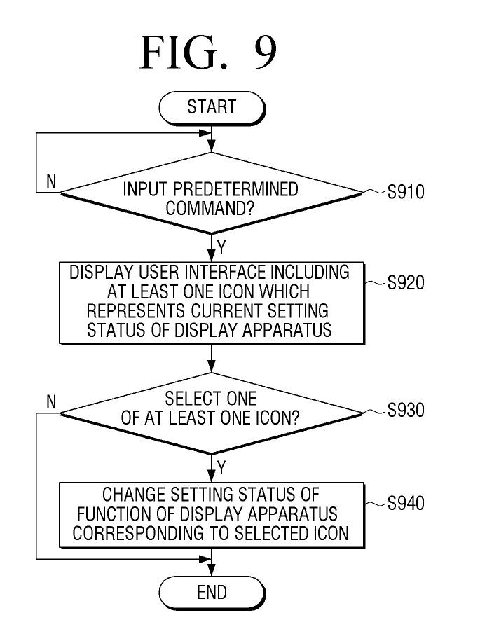

Hereinafter, the method for providing a user interface of the display apparatus 100 will be explained with reference to FIG. 9.

The display apparatus 100 determines whether a command, which may be predetermined, is input (S910). In this case, the command may be a command to select a specific key provided on a remote controller.

When a command, which may or may not be predetermined, is input (S910-Y), the display apparatus 100 displays a user interface including at least one icon which represents the current setting status of the display apparatus 100 (S920). In this exemplary embodiment, the display apparatus 100 may display a status check bar in the form of bar on the upper end of the display screen as illustrated in FIG. 3.

The display apparatus 100 determines whether one of the at least one icon is selected (S930).

When one of the at least one icon is selected (S930-Y), the display apparatus 100 changes the setting status of the function of the display apparatus 100 corresponding to the selected icon (S940). Specifically, if an icon corresponding to a function which is turned off is selected, the display apparatus 100 may turn on the function corresponding to the selected icon. Alternatively, if an icon corresponding to a function which is turned on is selected, the display apparatus 100 may display user interface to set the function corresponding to the selected icon in detail.

According to the above-described method, a user may check and change the setting status of various functions of the display apparatus 100 more easily and intuitively.

In addition, the method for proving user interface of a display apparatus according to the above-described various exemplary embodiments may be realized as a program provided in the display apparatus.

Specifically, if a command, which may be predetermined, is input, a non-transitory computer readable medium where a program including the step of displaying user interface including at least one icon which represents the current setting status of the display apparatus on one area of the display screen; and the step of, when one of the at least one icon is selected, changing the setting status of the function of the display apparatus corresponding to the selected icon is stored may be provided.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM and provided therein.

The foregoing embodiments and advantages are merely exemplary and are not to be construed as limiting. The present teaching can be readily applied to other types of apparatuses. Also, the description of the exemplary embodiments are intended to be illustrative, and not to limit the scope of the claims, and many alternatives, modifications, and variations will be apparent to those skilled in the art.

What is claimed is:

1. A method for providing a user interface of a display apparatus, the method comprising:
in response to a command being input, displaying user interface comprising at least one icon which represents a current setting status of the display apparatus on one area of a display screen; and
in response to an icon of the at least one icon being selected, changing a setting status of a function of the display apparatus corresponding to the selected icon.

2. The method as claimed in claim 1, wherein the at least one icon comprises at least one of an icon corresponding to a voice recognition function, an icon corresponding to a motion recognition function, an icon corresponding to a user log-in function, an icon corresponding a wired or wireless network setting, and an icon corresponding to a notification function.

3. The method as claimed in claim 2, wherein the changing the setting status comprises, in response to an icon corresponding to the current setting status being off being selected from among the at least one icon, turning on the setting status of the function of the display apparatus corresponding to the at least one icon.

4. The method as claimed in claim 2, wherein the changing the setting status comprises, in response to an icon corresponding to the current setting status being on being selected from among the at least one icon, displaying the user interface which is configured to set a function of the display apparatus corresponding to the selected icon in detail.

5. The method as claimed in claim 2, wherein the changing the setting status comprises, in response to the icon corresponding to the user log-in function being selected from among the at least one icon, displaying the user interface to perform user log-in.

6. The method as claimed in claim 2, wherein the changing the setting status comprises, in response to the icon corresponding to the wired or wireless network setting being selected from among the at least one icon, displaying the user interface for setting wired or wireless network setting.

7. The method as claimed in claim 2, wherein the changing the setting status comprises, in response to the icon corresponding to the notification function being selected from the at least one icon, displaying a list including notification information.

8. The method as claimed in claim 7, wherein the changing the setting status further comprises in response to an icon corresponding to a task performed by a current display apparatus being selected from the list, displaying an icon regarding change in a function of a task corresponding to the selected icon.

9. The method as claimed in claim 1, wherein the user interface comprises a bar that is displayed on an upper area of the display screen.

10. A display apparatus comprising:
a display;
an input unit configured to receive a user command; and
a controller configured to, in response to a command being received by the input unit, control the display to display a user interface comprising at least one icon which represents a current setting status of the display apparatus on one area of the display, and in response to an icon of the at least one icon being selected through the input unit, change a setting status of a function corresponding to the selected icon.

11. The apparatus as claimed in claim 10, the at least one icon comprises at least one of an icon corresponding to a voice recognition function, an icon corresponding to a motion recognition function, an icon corresponding to a user log-in function, an icon corresponding a wired or wireless network setting, and an icon corresponding to a notification function.

12. The apparatus as claimed in claim 11, wherein the controller is configured to, in response to an icon corresponding to the current setting status being off being selected from among the at least one icon through the input unit, turn on a setting status of a function of the display apparatus corresponding to the selected icon.

13. The apparatus as claimed in claim 11, wherein the controller is configured to, in response to an icon corresponding to the current setting status being on being selected from among the at least one icon through the input unit, control the display to display the user interface to set a function of the display apparatus corresponding to the selected icon in detail.

14. The apparatus as claimed in claim 11, wherein the controller is configured to, in response to the icon corresponding to the user log-in function being selected from among the at least one icon through the input unit, control the display to display the user interface for user log-in.

15. The apparatus as claimed in claim 11, wherein the controller is configured to, in response to the icon corresponding to the wired or wireless network setting is selected from among the at least one icon through the input unit, control the display to display the user interface for setting wired or wireless network setting.

16. The apparatus as claimed in claim 11, wherein the controller is configured to, in response to the icon corresponding to the notification function is selected from among the at least one icon through the input unit, control the display to display a list including notification information.

17. The apparatus as claimed in claim 16, wherein the controller is configured to, in response to an item corresponding to a task performed by a current display apparatus being selected from the list through the input unit, control the display to display an icon regarding change in a function of a task corresponding to the selected item.

18. The apparatus as claimed in claim 10, wherein the user interface comprises a bar that is displayed on an upper area of the display screen.

19. A display apparatus comprising:
a display;
a controller configured to control the display to display a user interface,
wherein the user interface comprises:
a setting status area that includes a plurality of icons and is disposed on a sub-portion of the display such that content is still viewable; and
a guide window configured to provide details corresponding to a selected icon from the plurality of icons, and
wherein at least one of the plurality of icons indicates a state of the icon functionality based on at least one of shape, color, and design of the icon.

20. A method for displaying a user interface, the method comprising:
displaying content on a display;
in response to a setting status request, displaying a user interface based on the setting status request,
wherein the user interface comprises a setting status area that includes a plurality of icons,
wherein the setting status area is disposed on a sub-portion of the display such that content is still viewable, and
wherein at least one of the plurality of icons indicates a state of the icon functionality based on at least one of shape, color, and design of the icon;
selecting at least one of the plurality of icons; and
setting associated icon functionality and displaying a guide window based on the selected at least one of the plurality of icons.
